(19) United States
(12) Patent Application Publication
(10) Pub. No.: US 2012/0275503 A1
(43) Pub. Date: Nov. 1, 2012

(54) METHOD OF TAGGING SIGNALS USED FOR LEAKAGE DETECTION AND/OR MEASUREMENT IN xDSL DATA TRANSMISSION NETWORKS AND APPARATUS FOR DETECTION AND/OR MEASUREMENT OF LEAKAGE SOURCES IN xDSL DATA TRANSMISSION NETWORKS

(75) Inventors: Wojciech SALA, Bielsko-Biala (PL); Jaroslaw SZÓSTKA, Poznan (PL)

(73) Assignee: KABELKOM SP. Z O.O., Bielsko-Biala (PL)

(21) Appl. No.: 13/438,986

(22) Filed: Apr. 4, 2012

(30) Foreign Application Priority Data
Apr. 30, 2011 (PL) P.394724

(51) Int. Cl. H04B 17/00

(52) U.S. Cl. 375/224

(57) ABSTRACT

A method of tagging signals for leakage detection and measurement in xDSL data transmission networks which uses additional signals carrying the tagging information and transmitted in these networks. A narrowband tagging signal or signals are placed in unused parts of an xDSL signal frequency spectrum or in its proximity.

### CROSS-REFERENCE TO RELATED APPLICATIONS

Pursuant to 35 U.S.C§119 and the Paris Convention Treaty, this application claims the benefit of Polish Patent Application No. P.394724 filed Apr. 30, 2011, the contents of which are incorporated herein by reference.

### BACKGROUND OF THE INVENTION

1. Field of the Invention

The present invention relates to a method of tagging signals used for leakage detection and/or measurement in data transmission networks as well as apparatus for the detection and/or measurement of leakage sources tagged with this method.

2. Description of the Related Art

Digital subscriber loop technology (xDSL) is used for information transmission over a subscriber (local) loop. The loop connects a subscriber's terminal endpoint (TE), installed at home or in the office, with a telecommunications provider's central office (CO) serving the terminal endpoint. Typically, a subscriber loop is a symmetric transmission line made of an unshielded pair of twisted copper wires. Many of currently used subscriber loops have been designed for analog phone services (POTS—Plain Old Telephone Service). With the xDSL technology, such a loop can be used for fast data transmission, access to the Internet and other multimedia services. The transmission speed can reach a few dozen Mb/s depending on the xDSL technology variant. The letter “x” stands for the technology variant, e.g., ADSL, VDSL or HDSL. Some of these technologies have been described in technical standards defining such parameters as modulation or bandwidth.

The spectrum of xDSL signals may occupy a bandwidth up to 30 MHz (VDSL2; this limit can be increased in the future). This broad spectrum shares frequency allocation with conventional radio communication systems (AM broadcasting) and radio amateurs. One of the problems faced by the xDSL system operators is signal leakage, which is undesirable electromagnetic radiation from a transmission line. An unshielded transmission line shown in FIG. 1, which is a twisted pair of wires, generates relatively high electromagnetic radiation. Currently, shielded twisted pair cables are often used. The shield of such cables can be damaged and such a damage can increase the radiation level. An additional source of leakage can be unloaded network branches, corroded or damaged connectors, bad quality or damaged network splitters or network modifications done by unqualified persons. The signals escaping from an xDSL network can undesirably interfere with terrestrial radio communication systems, causing problems with signal reception (e.g., interfered AM broadcasting on long, medium or short waves). Moreover, each discontinuity radiating the electromagnetic energy from an xDSL network forms a receiving antenna through which energy from terrestrial transmitters and other radio frequency sources (so called ingress) can enter the network. Most of leakage sources are also ingress sources. Ingress deteriorates the quality of the signals propagating in a xDSL network, reducing the transmission speed or the distance between a subscriber terminal and CO.

The above mentioned phenomena are the main reasons of leakage detection and measurement in xDSL networks.

Leakage control is vital for xDSL operators. In some countries there are regulations imposing radiation limits on xDSL networks. The Electromagnetic Compatibility (EMC) Directive 2004/108/EU, legally binding the member countries of European Union, comprises fixed telecommunication networks. Network operators should detect all leakage sources, determine the localization of leakage points, measure their absolute magnitude, and fix the sources which radiate stronger than a specified leakage limit.

A meter or detector for leakage measurement from xDSL networks should consist of an antenna and a receiver that is tuned to a frequency (referred as a test frequency) in the xDSL signal bandwidth. Such a device usually has a signal strength (the absolute value of the electric field intensity) measurement circuit. A typical method of leakage source detection requires a signal strength measurement on the test frequency. If the signal strength measurement circuit detects a relatively large amplitude signal at a particular location, a leak may be indicated in or near that localization. A technician may use a leakage detector to pinpoint the source of a leak. A corrective action may be taken to remove the leak source from the network.

Establishing one frequency of a xDSL signal, which would be transmitted continuously with constant amplitude, is a big problem. It makes impossible to assess the absolute leakage amplitude (electric field intensity). Moreover, the drawback of the method of leakage detection based on the measurement of the chosen frequency in the xDSL signal spectrum is its inability to distinguish between leakage radiated by the tested xDSL system and other signals present in the same frequency band. For example, the detected signal can be radiated by terrestrial transmitters, other radio frequency sources or xDSL networks placed in the same area and belonging to other operators. Another drawback of the method would be the necessity of xDSL signal modification in order to tag it. Such a modification could negatively affect the signal quality.

So far, the methods of tagging leakage signals from xDSL networks are unknown. On the market one can find very few devices for measurement leakage from xDSL networks. An example of such device is the HST-3000C meter manufactured by JDSU, USA. The meter has a spectrum analyzer. During the leakage measurement, the spectrum analyzer is in the Span Zero mode and analyzes the received signals in the time domain. The received signal is considered as a leak when the meter recognizes (automatically or by a technician—depending on the operation mode) that the signal in the time domain has a pattern typical for a xDSL system. The described method is not effective when other xDSL networks belonging to various operators have been deployed in the same area. The described method of leakage detection does not allow to unambiguously determine the network from which the leak comes from.

Accordingly, there is a need to develop a leakage tagging method that does not modify the signals transmitted in a xDSL network, does not decrease the reception quality in subscriber terminals and is not susceptible (at least to a certain extent) to interfering signals coming from other sources of electromagnetic energy. The method should also allow accurate measurement of the leak absolute magnitude.

### SUMMARY OF THE INVENTION

According to the present invention, the method of tagging the signals used for leakage detection and/or measurement in networks with digital subscriber loops (xDSL) using additional signals transmitted in these networks and carrying the tagging information is based on placing a narrowband tagging signal (or signals) in chosen parts of the frequency spectrum which are close to the spectrum occupied by the xDSL signals transmitted in a network.

The tagging signal (or signals) is narrowband, with the bandwidth being from a few kHz up to several kHz.

The apparatus for leakage detection and/or measurements from xDSL networks, tagged according to the method presented in the invention, which uses the principle of signal reception based on frequency conversion, has a narrowband filter (or filters) with a bandwidth from a few kHz up to several kHz for the separation of the tagging signals.

The filter output is connected with the microprocessor input. The microprocessor is connected with an antenna switch, an amplifier, a voltage controlled generator, a display and a keyboard and has been programmed for sampling and quantizing of the input signal and for the detection of the spectrum components carrying the tagging information.

The microprocessor uses the fast Fourier transform (FFT) or the discrete cosine transform (DCT) algorithm.

The innovation of the present invention lies inter alia in the placement of a tagging signal within the bandwidth which is in close proximity of the bandwidth occupied by a digital signal used for the transmission of services in a xDSL network. The tagging signals can be inserted by means of an external generator, a so called tagger, or can be created in the terminal end-point by means of the modified firmware of the terminal. At both ends of the bandwidth occupied by a xDSL signal, there are always free frequency bands. There is no useful energy (coming from the modulation process) generated by xDSL equipment and transmitted in these bands. If a narrowband tagging signal (or signals) is placed in the free bands, the xDSL signal quality will be unaffected. The tagging signal or signals will propagate in a transmission line together with the xDSL signal.

According to the present invention, any narrowband signal with any type of analog or digital modulation can be used as a tagging signal. For example, a tagging signal can be a sinusoidal wave which is modulated with amplitude. The modulation frequency is low, in the range from 1 to 50 Hz, in order to minimize the bandwidth occupied by the signal. The usage of a sinusoidal wave simplifies the measurement of the absolute magnitude of the leakage by a leakage meter or detector. The narrowband tagging signal (not only sinusoidal) can be extracted in the leakage meter or detector by means of, for example, the fast Fourier transform (FFT), the discrete cosine transform (DCT), or a very narrow bandpass filter, which attenuates the spectrum of the signals not lying in the tagging signal band. The narrowband tagging signal substantially improves the accuracy of leakage magnitude measurements. The above described sinusoidal signal with amplitude modulation is one possible form of the tagging signal.

A greater number of tagging signals, which can be used in the methods described herein, increases the leakage meter/detector immunity to interfering signals and reduces the likelihood that the detected leak comes from a network other than the network under test.

One advantage of the invention is the possibility of fast and effective leakage and ingress source localization. The invention simplifies maintaining the high quality of signals transmitted in xDSL networks.

### BRIEF DESCRIPTION OF THE DRAWINGS

Embodiments of the present invention will now be described, by way of example, with reference to the accompanying drawings in which:

FIG. 1 is a typical configuration of a xDSL network using a twisted pair of wires for signal transmission;

FIG. 2 is an example of placing the narrowband tagging signal TS in close proximity of the spectrum occupied by a xDSL signal;

FIG. 3 is a block diagram of a typical xDSL system incorporating the signal tagging method according to an exemplary embodiment of the invention; and

FIG. 4 is a block diagram of a leakage meter and/or detector leakage detection from a xDSL network which incorporates the method of signal tagging according to an exemplary embodiment of the invention.

### DETAILED DESCRIPTION OF THE INVENTION

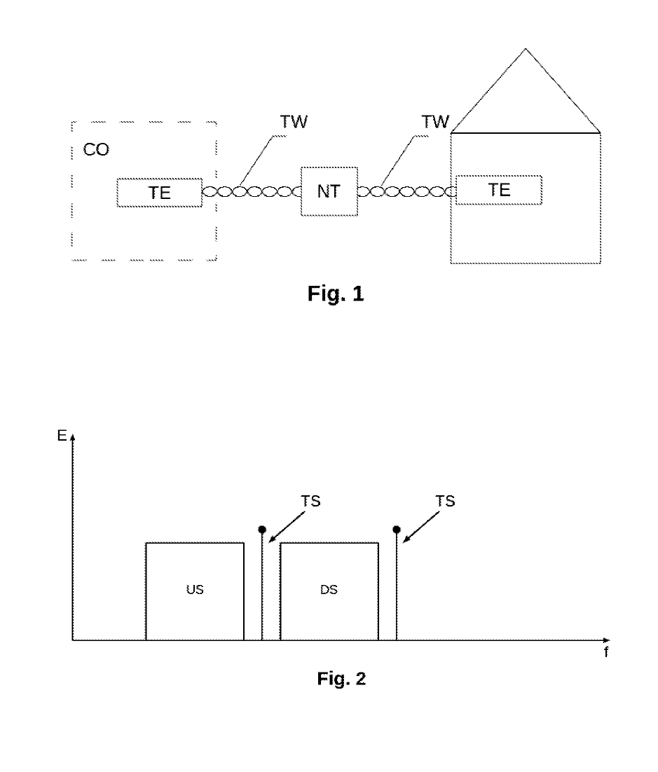

A typical system of a digital subscriber loop (xDSL), shown in FIG. 1, consists of the following parts: a communication node (central office—CO), belonging to a service provider, in which there is an end terminal TE, a transmission network made of a pair of twisted copper wires TW, an optional network terminal NT, and an end terminal TE placed at subscriber's home or office. The terminal TE provides conversion, modulation/demodulation, and data transmission/reception. The transmission line TW may have too high attenuation and this is why an optional device NT is sometimes used to amplify a signal, so the TW length can be extended.

FIG. 2 presents an exemplary frequency spectrum (distribution of energy E in terms of frequency f) of a xDSL signal. The spectrum consists of a DL part, which serves for transmission from a communication node CO to a subscriber's terminal TE, and an UL part for transmission in the reverse direction. A narrowband tagging signal TS may be placed in the spectrum part which separates UL from DL or above the whole band occupied by an xDSL signal. Due to better radiation it is advised to use higher frequencies for leakage tagging.

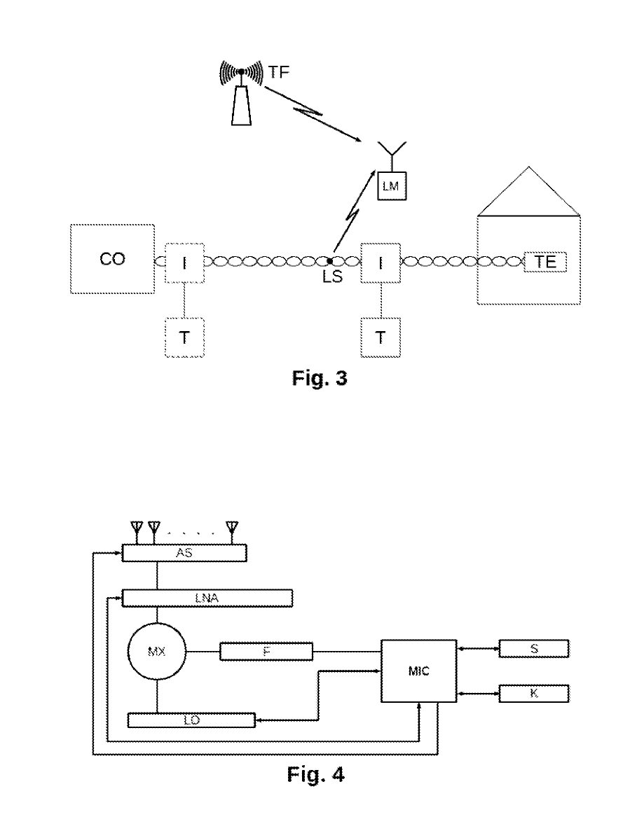

FIG. 3 presents a typical xDSL network with a tagger T installed for leakage tagging using the method according to the invention. The tagging signal is inserted into the network via an inserter (coupling device) I which can be close to a subscriber's terminal or a communication node CO (marked with a dashed line). A leakage source LS radiates electromagnetic energy which is received by a leakage meter LM.

Assuming that there is an interference source radiating the signal on exactly the same frequency TF as the frequency generated in the tagger T, the leakage meter LM can receive the interfering signal. However, the interfering signal does not contain the tagging information, so the received signal will not be recognized as a leak from the network under test.

The process of leakage detection using the method according to the invention is as follows. The tagger T is connected to that part of a xDSL network which requires testing or is suspected as radiating leakage (e.g., excessive leakage). The choice of the suspected part of a network can be based on an earlier measurement of a power level which has given higher levels above the noise floor in the part of the spectrum used for data transmission in this network. Such a measurement can be done during a mobile patrol with a car antenna and a spectrum analyzer which can be built in a leakage meter/detector or be a stand-alone device. After switching on a tagging signal, a technician performs a mobile patrol, during which he determines the geographical coordinates of the locations where a leakage meter or detector has detected the tagging signal from the network under test with the amplitude higher than the established limit. In the next step, the technician exactly localizes the leak sources and fixes them during a pedestrian patrol.

FIG. 4 presents a block diagram of the leakage meter and/or detector which uses the method of signal tagging according to the invention. The apparatus for leakage measurement and/or detection according to the method described herein has good sensitivity, dynamic range and the detection ability of tagging signals. There is an antenna switching circuit AS at the input of the apparatus. The meter and/or detector has a built-in internal antenna and allows for the connection of external measurement antennas (e.g., kept in hand or placed on a vehicle roof). The signal received by the antenna is amplified in the input low noise amplifier LNA. The amplified signal appears at the input of the mixer MX. The second input of the mixer is connected to the variable local oscillator LO. The mixer MX shifts the input signal on the frequency axis by the frequency of the local oscillator signal. The signal at the mixer output has the frequency lying within the bandwidth of the narrowband filter F (the bandwidth is from a few kHz up to several kHz). The filter F attenuates all the signals lying outside the narrow band with the tagging signal and coming from the xDSL network under test, other networks or terrestrial sources which can interfere with the tagging signal. The parameters of the filter F (bandwidth, frequency response slope) have substantial influence on the correct detection and measurement of the leaking signal. The output signal of the filter F enters the input of the microprocessor MIC. The microprocessor MIC has control functions (it controls the antenna switch AS, the amplifier LNA, the oscillator LO, the screen S, and the keyboard K) and digitally processes the signals. The digital signal processing in the microprocessor MIC comprises sampling and quantization of the input signal as well as the recognition of the spectrum components carrying the tagging information. The detection of the spectrum components with the tagging information (introduced in the process of the narrowband modulation of the tagging signal in the tagger T) is based on the fast Fourier transform (FFT) algorithm. Using this processing method, a very good sensitivity of tagging signal detection is achieved. The microprocessor MIC also determines the amplitude of the received leakage signal. Information about the leak magnitude and the presence of the tagging signal is displayed on the screen of the apparatus. The usage of the microprocessor allows for the correction of the systematic errors. The correction values added to the measurement results are saved in the microprocessor memory during the periodical calibration of the meter/detector.

An alternative example of the leakage meter/detector embodiment according to the invention has a different microprocessor program, which uses the discrete cosine transform (DCT) for detection of the spectrum components carrying the tagging information. Similarly, a high sensitivity of the tagging signal detection has also been achieved.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. A method of tagging signals used for leakage detection and/or leakage measurement in data transmission networks; the data transmission networks comprising a digital subscriber loop xDSL carrying an xDSL signal frequency spectrum; the method comprising placing a narrowband tagging signal or narrowband tagging signals in an unused part or unused parts of the xDSL signal frequency spectrum or in a proximity of the xDSL signal frequency spectrum.

2. The method of claim 1, wherein said narrowband tagging signal or narrowband tagging signals are extraneous and additional to signals normally carried by the data transmission networks; and said narrowband tagging signal or narrowband tagging signals carry tagging information.

3. The method of claim 1, wherein said narrowband tagging signal or narrowband tagging signals have a bandwidth of from a few kHz up to several kHz.

4. An apparatus for leakage detection and/or leakage measurement in data transmission networks; the data transmission networks comprising a digital subscriber loop xDSL carrying an xDSL signal frequency spectrum tagged using the method of claim 1; the apparatus comprising:
a narrowband filter or filters for tagging signal extraction having a filter output;
a microprocessor having a microprocessor input;
an antenna switch;
an amplifier;
a variable frequency local oscillator;
a screen; and
a keyboard; wherein
said narrowband filters have a bandwidth of from a few up to several kHz;
said filter output is connected to said microprocessor input;
said microprocessor is connected to said antenna switch, said amplifier, the said variable frequency local oscillator, said screen, and said keyboard (K); and
said microprocessor is programmed for sampling and quantizing of an input signal and for the detection of spectrum components carrying tagging information.

5. The apparatus of claim 4, wherein said apparatus uses frequency conversion reception of signals.

6. The apparatus of claim 4, wherein said microprocessor uses fast Fourier transform for leakage detection and/or leakage measurement.

7. The apparatus of claim 4, wherein said microprocessor uses discrete cosine transform for leakage detection and/or leakage measurement.

8. An apparatus for leakage detection and/or leakage measurement in data transmission networks, which uses the method of claim 1 for tagging signals.

9. An apparatus for leakage detection and/or leakage measurement in data transmission networks using the method of claim 1; the apparatus comprising a narrowband filter or filters and a microprocessor; wherein said narrowband filter or filters attenuate signals other than said narrowband tagging signal or narrowband tagging signals; and said microprocessor carries out sampling and quantizing of an input signal and detection of spectrum components carrying tagging information.
